(19) United States
(12) Patent Application Publication
(10) Pub. No.: US 2005/0004927 A1
(43) Pub. Date: Jan. 6, 2005

(54) Intelligent and automated system of collecting, processing, presenting and distributing real property data and information

(76) Inventor: Joel Singer, Tarzana, CA (US)

Correspondence Address: BINGHAM, MCCUTCHEN LLP, THREE EMBARCADERO, SUITE 1800, SAN FRANCISCO, CA, 94111-4067, US

(21) Appl. No.: 10/860,323

(22) Filed: Jun. 1, 2004

Related U.S. Application Data
(60) Provisional application No. 60/475,584, filed on Jun. 2, 2003.

(51) Int. Cl. G06F 17/00

(52) U.S. Cl. 707/100

(57) ABSTRACT

Software has been developed that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set. A system for identifying, retrieving and manipulating real property data and information has been developed, wherein the system includes: a) real property data from at least one source; b) software that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set; and c) a display apparatus for displaying the results set.

This application claims priority to U.S. Provisional Application Ser. No. 60/475,584 filed on Jun. 2, 2003, which is incorporated herein in its entirety.

### BACKGROUND OF THE SUBJECT MATTER

The real property business and market has steadily evolved over the years to make the timely reception of accurate information valuable and in some cases, indispensable. Currently, for most residential and commercial real property agents, developers and builders it can be difficult to cost-effectively retrieve and distribute a wide range of real property information. Real property information can comprise information related to the listing and sale of property, county assessor information, title, natural hazard data, etc.

One of the most frequently used systems by REALTORS®, is a Multiple Listing Service (MLS). These systems act as the primary source for information regarding the sale of real property. REALTORS® subscribe to and access one or more of these systems depending upon the geographic area in which they work. Often times, these systems each work differently based upon the vendor systems that have been implemented at each MLS.

In California, there are approximately 70 Multiple Listing Systems organizations serving REALTORS®. Some of these MLS organizations are regional in nature, spanning a large geographic area and having 8,000 to over 20,000 customers accessing the system. Others may cover a very small area and service a few hundred customers. These systems may utilize one of many different vendor systems, or may be a custom in-house developed system. The following is a list of many, but not all, of these MLS system vendors:

| Vendor Name | Product Name |
|---|---|
| FBS Data | FlexMLS |
| First American Real Estate | Fusion MLS |
| Fidelity National Information Systems | Paragon |
| | RISCO (Galaxy) |
| | VISTAInfo(RE/Xplorer ®) |
| Interealty | MLXchange |
| MarketLinx | Tempo |
| Rapattoni | Rapattoni MLS |
| Solid Earth | List It |
| Wyldfyre Technologies | WyldFyre Listings |

The Real Estate Transactions Standard (R.E.T.S) has been established to fill a void and provide a mechanism for sharing data within a defined standard (http://www.rets-wg.org/). Most, if not all, of the MLS systems appear to be R.E.T.S. compliant. However, their level of compliance is not clear, and no formal certification appears to exist. In addition, there is no easy way of accessing and manipulating data from more than one MLS or other source at a time even though most or all of the sources of information comply with the RETS standard.

In order to provide a system unlike those currently in use, a system should be developed that: a) provides boundaryless data access, b) provides a set of tools that allows someone to directly access a wide range of real property data from various sources within a secure computing environment; c) encompasses the widest possible range of system components, including but not limited to the evolving needs of wireless; d) incorporates an existing data exchange standard developed by the National Association of REALTORS® (NAR) known as the Real Estate Transactions Standard (RETS); e) focuses on the search and retrieval of property listing data; f) addresses the next generation of tools (based on P2P); g) reduces costs; h) provides better customer service to agents and therefore consumers; i) simplifies the access to information; j) minimizes the time and effort required by data providers and clients to obtain and share property listing data, and k) provides a consistent technical interface for clients and data providers to get access to real estate data state-wide—“Implement once and get access to all data”.

A set of software tools and a related system for utilizing those software tools should also be developed that allow for the exchange of any suitable real property data within a peer-to-peer environment. These tools should allow someone to directly collect a wide range of real property data information from various sources within a secure computing environment, and should be developed to encompass the widest possible range of system components, including but not limited to the evolving needs of wireless. These tools should also incorporate the previously mentioned existing real estate and real property data exchange standard developed by the National Association of REALTORS® known as the Real Estate Transactions Standard (R.E.T.S). It is a requirement that these tools operate and exchange data within this defined standard. Recognizing that the current standard may not fully address specific needs within California, a significant expansion of this standard is to be undertaken. This system and standard should also be developed in order to address unique needs within the California real property environment, but should also be easily adaptable to other states.

In order for any system developed to be useful, the following overall goals and objectives should be met: a) ensure the highest possible level of data security and access integrity at all levels; b) reasonable response time for accessing data; c) designed for mission critical stability and behavior; d) scalable; e) allows for queuing or buffering of transactions; f) time-stamps transactions, and f) simple enough for easy implementation by MLS staff and end users.

### SUMMARY OF THE SUBJECT MATTER

Software has been developed that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set.

A system for identifying, retrieving and manipulating real property data and information has been developed, wherein the system includes: a) real property data from at least one source; b) software that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set; and c) a display apparatus for displaying the results set.

### BRIEF DESCRIPTION OF THE FIGURES

FIG. 1 shows a contemplated embodiment comprising a hosted P2P Registry and Service Provider Model—Service Provider Mode.

FIG. 2 shows a contemplated embodiment comprising a distributed P2P Registry and Service Provider Model—Product Mode.

FIG. 3 shows a contemplated embodiment of the Intelligent Agent.

FIG. 4 shows a schematic diagram of a contemplated embodiment of the system described herein.

FIG. 5 shows a schematic diagram of a contemplated embodiment of the system described herein.

### DESCRIPTION OF THE SUBJECT MATTER

An intelligent and automated system of collecting, processing, presenting and distributing real property data and information has now been developed that meets the following overall goals and objectives: a) ensures the highest possible level of data security and access integrity at all levels; b) reasonable response time for accessing data; c) designed for mission critical stability and behavior; d) scalable; e) allows for queuing or buffering of transactions; f) time-stamps transactions, and f) simple enough for easy implementation by MLS staff and end users. In addition, there is now an easy way of accessing and manipulating data from more than one MLS or other source at a time.

Specifically, in accordance with the goals and needs previously mentioned, a system has been developed that: a) provides boundaryless data access, b) provides a set of tools that allows someone to directly access a wide range of real property data from various sources within a secure computing environment; c) encompasses the widest possible range of system components, including but not limited to the evolving needs of wireless; d) incorporates an existing data exchange standard developed by the National Association of REALTORS® (NAR) known as the Real Estate Transactions Standard (RETS); e) focuses on the search and retrieval of property listing data; f) addresses the next generation of tools (based on P2P); g) reduces costs; h) provides better customer service to agents and therefore consumers; i) simplifies the access to information; j) minimizes the time and effort required by data providers and clients to obtain and share property listing data, and k) provides a consistent technical interface for clients and data providers to get access to real estate data state-wide—“Implement once and get access to all data”. As used herein, the phrase “boundaryless data access” means that a client may access a wide range of real property data from a variety of sources within a secure computing environment and/or may encompass the widest possibly range of system components, such as those associated with wireless devices.

Software has now been developed that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set. As opposed to conventional software applications, the software and related systems described herein are designed to be utilized by at least two data providers and at least one client.

A system for identifying, retrieving and manipulating real property data and information has been developed, wherein the system includes: a) real property data from at least one source; b) software that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set; and c) a display apparatus for displaying the results set. As mentioned earlier, contemplated systems are designed to be utilized by at least two data providers and at least one client.

As used herein, the term “node” means any point within the intelligent and automated system disclosed herein. The phrase “a node environment” means the collection of nodes that make up contemplated systems described herein. It is contemplated that the node environment comprises at least one data provider and at least one client and may also include at least one service provider. A node environment may also comprise at least one computer system, at least one modem or data transmission device, at least one monitor, at least one server system, at least one hub and/or router or a combination thereof. The phrase “data providers” is contemplated to be used interchangeably with the term “source”, wherein both terms, as used herein, mean any node that provides data related to at least one property. Contemplated data providers comprise MLSs, participating brokers, appraisers, title companies, public records or a combination thereof. The phrase “service providers” means any central registry node. The central registry node or service provider concept is analogous to the concept of a primary and secondary Domain Name Server (DNS) used to identify Internet addresses. The service provider, at a minimum, will provide central registry and authentication capabilities that function similar to yellow pages to identify data providers internet addresses and areas they serve. The term “client” means any node that makes a request for information. Generally, the client will comprise an agent or broker. The term “peer” refers to data providers. Data providers exchange data with one another. The phrase “RETS Compliant” refers to servers and clients that support the RETS protocol per the RETS specification. Specific requirements for the intelligent and automated system contemplated and described herein are provided herein.

Several business and technical requirements have been recognized and developed to facilitate implementation of contemplated intelligent and automated systems described herein. In general, contemplated intelligent and automated systems, such as those described herein provide boundaryless access to data (i.e. an agent, developer or builder has access to all participants data), minimizes time and effort required by data providers and clients to attain and share real property information (MLS data), and provides one consistent interface for clients and data providers to get access to real property data and information over a particular geographic area, such as statewide. Application and performance monitoring reports are provided by contemplated systems. It is contemplated that the intelligent and automated systems described herein can support 100K+ clients and 70+ data providers. In addition, intelligent and automated systems described herein are flexible enough to support several user roles. For example, Table 1 shows some of the basic user roles that are supported:

TABLE 1

| Roles for System | Description |
|---|---|
| Generic User (Default) | User who is not a member of the |
| | data provider he is searching |
| | Will get access to a preset list of data fields. |
| Privileged Associated User | User who is not a member of the data |
| | provider he is searching, however, his |
| | data provider has a special reciprocal |
| | agreement in place with the data |
| | provider he is a member of. |
| | User will get access to a preset list of data |
| | fields plus extra fields that are |
| | definable through a contemplated system. |
| Privileged User | User who is a member of the data |
| | provider he is searching. |
| | Will get access to a preset list of data fields |
| | plus all privileged data fields that |
| | the data provider shows to its members |
| Data Provider | User who will be responsible for maintaining |
| Administrator | the operational data for that data provider |
| System Administrator | User who will administer and change |
| | configuration parameters of a |
| | contemplated system. |

Intelligent and automated systems and related software contemplated herein can search for property listings (all types), property history, agents, offices and tax data, can view and download the search results for any search conducted on the system, can update property listings, can provide prospecting services, such as a listing watch and can generate various reports, including CMA's.

Contemplated systems can operate in multiple environments on the client side, including an Internet browser or a hand-held device (PDA, Blackberry™). A RETS compliant client is required at a minimum to be able to read and display the returned search results. Contemplated RETS compliant clients may be those that are already available on the market or those that are developed and offered as an additional component of the intelligent and automated systems described herein. It is contemplated that personalization can be provided to support future services such as prospecting. Particularly the HTML clients want to personalize contemplated systems to their Internet preferences (e.g., my YAHOO™). Depending on their usage patterns, at various stages of their transaction the user could be prompted with any number of promotional or informational messages in a contextual basis.

Systems described herein can search criteria fields that can be defined during the detailed design. A wide selection of fields are available for property listing data, including area/neighborhood, price, number of bedrooms, number of bathrooms, sales status. Contemplated systems summarize results fields and detailed results fields that are defined during the design. Data providers and client systems may support RETS protocol over http, and data providers systems should provide at least T1/DSL or comparable connection to the Internet or a similar web-based system. For any browser clients, at least Netscape 4.7× and IE 4.× should be supported, and other browser software and configurations are contemplated. As used herein, the term “localization” is the customizing of a site for users in different countries/cultures. In contemplated embodiments, localization is not a requirement for the systems described herein.

It is a requirement that every client and data provider server in the subsystem will support Real Estate Transaction Specification (RETS) or a similar specification system. RETS is a set of data interchange standards that facilitates the free flow of information between various users of the real estate transaction data. The RETS XML DTD and protocol are standards created by National Association of Realtors® (NAR). These standards are well documented, and the documentation is available at http://www.rets.org.

In some embodiments, business rules for data access are supported at the system tool layer. It is contemplated that Business Rules/Contracts Modules can be included in the software and in the system to provide access control over the data. When a search request is made, this module performs the following functions: a) lookup of which data providers can communicate to which data providers; b) lookup of which fields each data provider can view; c) lookup of the business rule filters. Data Providers will have the capability to define various business rules or data filtering based on reciprocal agreements, user roles, data fields, etc. Business rules for data access to the software and systems contemplated herein are in addition to any business rules implemented by the data provider at the data provider layer. Contemplated software and systems mimic the reciprocal agreements that are currently in place between the MLS's. For example, if a data provider displays 10 fields to non-privileged users, other data providers may display only those same 10 fields back for that data provider. So, the data provider may decide to only show “x” number of fields, where “x” is an integer. For privileged users, the data provider may decide to show “x+y” fields, where “y” is an integer and represents the number of fields only shown to the privileged user or other class of user besides the non-privileged users. In contemplated embodiments, the software and/or system can store the fields that each role can see, and the data provider can maintain such information. An administration module can be utilized for each data provider to maintain contemplated business rule information.

In order to sort and provide information that is useful to the users, searches can be restricted by any variable, such as geography (map coordinates, zip code, city), square feet or number of rooms. Contemplated software and/or systems will assume that the searchable fields are uniformly available across all data providers. Contemplated software and/or systems also assume that data providers support search transactions uniformly. This assumption may be addressed via a CAR version of the RETS standard. In general, searches are performed using standard names only (such as XML DTD). It is contemplated that software and/or systems described herein can track each user's access to data. Content management is contemplated, and in some embodiments, provided to support future services such as support of additional media types (video, audio, etc.).

In contemplated embodiments, the Search Module is the engine for client search requests. Various searches will be supported, however, due to varying levels of vendor support for RETS searches, the implementation of searches will be phased. For example, searches in Phase 1 may comprise searches for property, active agent, agent or office. Subsequent searches (Phase 2) may comprise property history, tax information, prospect information, open house information and tour information. Contemplated searchable fields, summary result sets and detail results sets are any suitable and acceptable searchable field, summary result set and detail results set, including those available in the art and/or the “lowest common denominator” fields, which will be identified to support the greatest number of data providers and geographical areas.

As mentioned, RETS compliant XML output, data and/or information is provided to the client (agent) and/or user by contemplated software and/or systems described herein. The response data can be fully encrypted or not encrypted at all. Partial field encryption may also be an option with contemplated systems. Property data responsibility resides at both the data provider level and the service provider level in contemplated systems. The software and/or system can mimic the reciprocal agreements that exist today between MLS's. Application data, which may consist of registry, security and location data provider mappings, resides at the service provider. The application data is not generally migrated from an existing system. Systems described herein require a database to store the application data. Some of that data that the software and/or system can store are as follows: a) registry data (a mapping of data providers to the map coordinates, zip code or city of areas they service); b) security data (such as roles, users) and/or c) location data.

A Registry Module may be provided in contemplated software and/or systems, wherein the Registry Module provides the directory lookup services to the data providers and supports the search modules. Registry Module functions include: a) lookup of which data providers provide data to certain zip codes, cities or map coordinates; b) contacts each of the data providers for the data for a specific zip code; and/or c) collects and gathers the returned list of property listings provided by the data providers.

An Administration Module may be provided in contemplated software and/or systems, wherein the Administration Module provides the functions to maintain application data, including users, roles and business rules in contemplated systems. Functions that may be included (alone or in combination) are: a) adding a new user; b) adding a new data provider; c) allowing data providers to add their privileged users; d) allowing data providers to associate to other data providers; e) role definition; f) data field definition; g) role to data field associations; h) role to data field definition associations; i) add users and assign them to their data providers with the role of a privileged user (data provider will only add his own privileged users); j) data providers can set up access URL and define which zip code areas that they conduct business; k) reporting module for usage reporting, and l) provide online help for the administration module.

With respect to security, contemplated systems have at least some level of data security and access integrity at all levels as is available in current MLS environments. In contemplated software and/or systems, access requires at least a username and a password. In other embodiments, additional security-related information may be required. In some contemplated embodiments, protocol support is consistent across all data providers. For example, the protocol should either be “http” for unencrypted systems and “https” for encrypted systems.

Software and/or Systems disclosed herein have the capability of adding new users to the systems and updating the users information. Login and permissions modules are contemplated to be a part of contemplated software and/or systems described herein to provide secure access to contemplated systems by providing login capabilities, looking up which users have permission to access the software and/or system, and looking up what roles/access rights each user has with the software and/or system. Individual users may be given the capability to update his/her own personal information, including the password. In contemplated software and/or systems, the security administrative function maintains data provider addresses and service areas. Also in contemplated software and/or systems, privileged access rights exist between data providers. For example, two different offices of Prudential (e.g. SF Prudential Office and Sacramento Office) could be set up as different data providers and contemplated systems, such as those described herein have the capability to associate the privileged users of one office with the privileged users of another office. The same may be true for unaffiliated brokerages e.g. Caldwell Banker and Prudential. Several basic assumptions may exist with respect to permissions and authentication, such as a) security and permission schemes are provided; b) user roles are minimal in number and are uniform throughout data providers' RETS implementation (simplifying roles help in uniform implementation of authorization); c) user administration and registry modules are browser based; d) LDAP and Database are two contemplated candidates to implement the security and roles model; e) data currently is as a whole encrypted or as a whole not encrypted; f) entitlements are provided through an Access Control List (ACL) or it may be user based or a combination of both, and g) the existing users are maintained through a combination of the data provider and the user them selves. The data provider will set up the user's account initially.

With respect to application error handling, a service provider dispatches requests to many data provider systems, consolidates the returned information, and deals with failure of any of the individual data provider's systems in a method that is transparent to the client. The service provider functions normally even in the case of a data provider failure. The service provider will notify the client, in some meaningful way, should a server fail (eg. message that data provider X was unavailable).

With respect to current performance and future expansion, contemplated systems are expandable to support over 100K clients and over 70 data providers. It is estimated that at least about 5 to 15% of the registered members would be online at any one time. Contemplated software and/or systems should have acceptable response time for accessing data. In some contemplated embodiments, the current response times are between about 2 and 5 seconds. It should be expected that contemplated systems support more users during peak times of Monday through Friday from 10 AM to 6 PM. Contemplated systems are geographically distributed for high-availability and fail-over. Contemplated systems are also designed for mission critical stability and behavior (24 hours/7 days uptime). It is contemplated that the system is no worse than the best MLS with regard to mission critical stability and behavior. Contemplated systems are scalable and designed to be expandable to include other future real property and real estate standards other than RETS.

Contemplated software and/or systems, such as those described herein, are designed to be offered in either a service or product operational mode. It is important that the implementation choices be flexible to accommodate some of the non-technical issues such as data ownership, access rights etc. The system architecture is flexible to support either of these operational modes or a combination of both:
Service—Hosted P2P Registry and Service Provider Model
Product—Distributed P2P Registry and Service Provider Model
Combination of Service and Product

It is contemplated that the Operational Mode will comprise a combination of both to support the needs of all data providers. Some data providers may wish this service to be hosted and some may wish to host it themselves. FIG. 1 shows a contemplated embodiment that comprises a hosted service provider model. In this model, the contemplated system is centrally hosted. Every participating data provider (110) provides their data via a RETS server (115). Each data provider (110) may maintain a set of business rules to filter data for the users/clients (101). All user login and authorization information is maintained at the contemplated system (120). Registry data (130), which maintains the mapping between zip codes and data providers, is also maintained at the contemplated system. All requests pass through the contemplated software and/or system. In this mode, the contemplated software and/or system can support RETS clients, HTML and WML (wireless) browser clients.

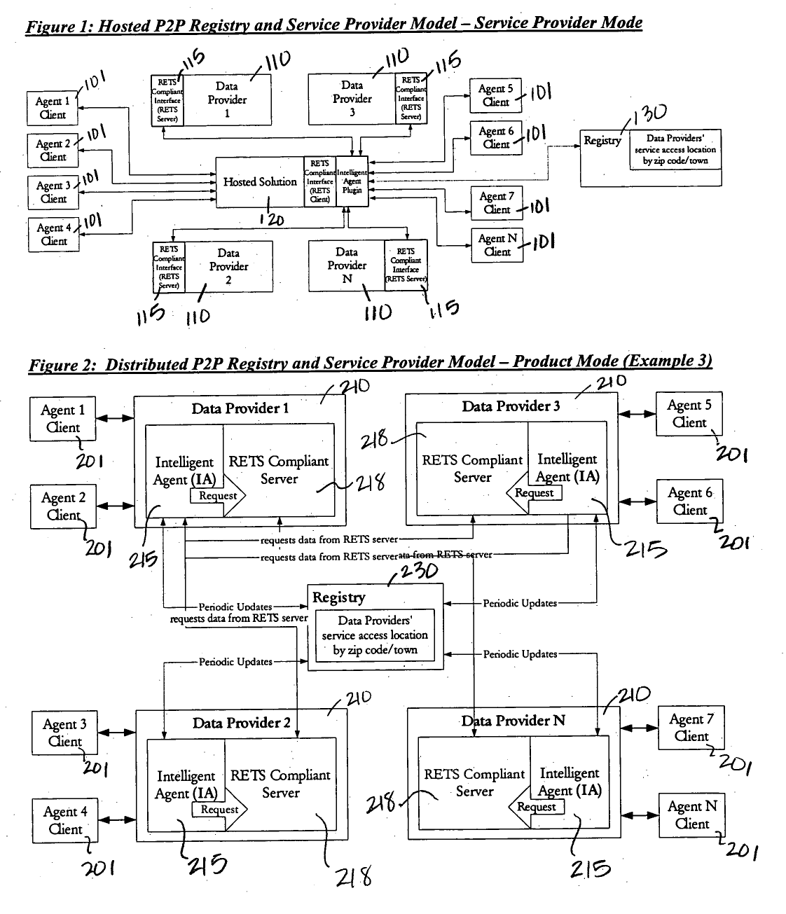

FIG. 2 shows a contemplated system as described herein in product mode. In this scenario, the system (215) is deployed at each of the data providers' systems (210). The data provider (210) locally maintains users/clients (201) belonging to the data provider (210). The contemplated system in FIG. 2 is built so that it can be adopted to easily use the existing security infrastructure of the data provider (210). A central registry (230), which maintains the mapping between zip codes and data providers (210), is maintained separately. The system functions exactly the same way as described in the service provider mode. The system contacts the other data providers' systems (210) using their RETS servers (218).

It is contemplated that a Registry Component provides the same functions and services regardless of operational modes (service or product). The Registry Component is a central entity that provides at least the following services: a) maintenance of the master list of the data providers—RETS CI Server URL—Zip code Mappings; b) the data providers may be able to log in to this location to maintain their geographic service area details, and/or c) migrate changes in the master list, on a regular basis to participating data providers.

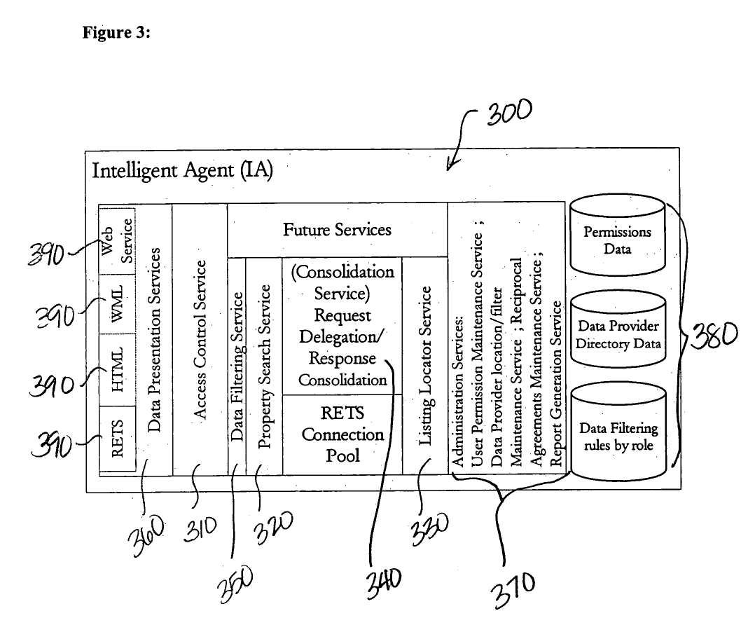

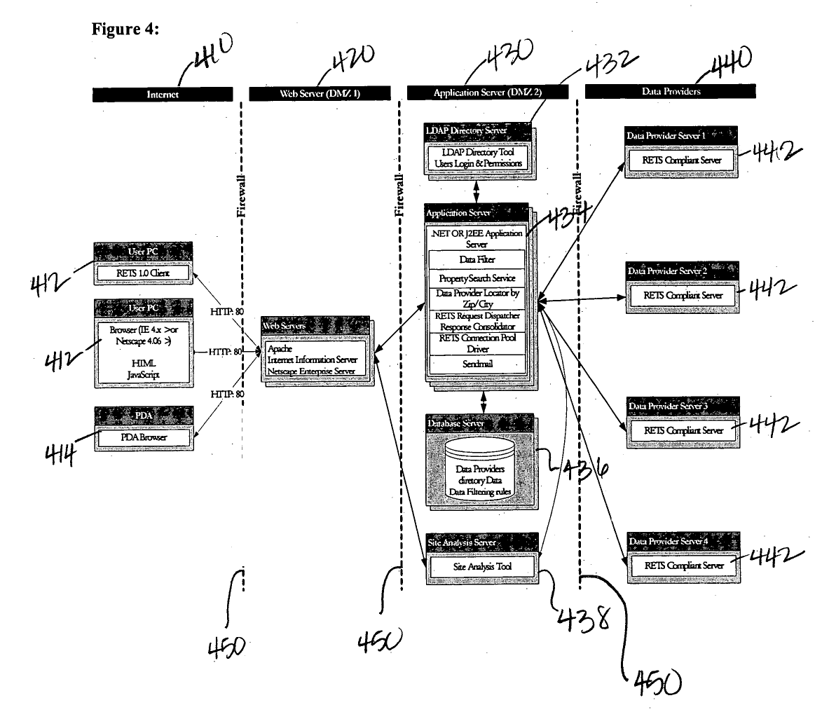

Contemplated software and/or systems described herein provide at least the same functions and services regardless of operational modes (service or product). In some embodiments, a contemplated system may be described as an “Intelligent Agent”. There may be a few implementation nuances based on operational mode, which will be highlighted in the following subsections as they apply. The architecture for a contemplated system (300) is illustrated FIG. 3. FIG. 4 shows the components interaction in one embodiment of the system described herein. In FIG. 4, the Internet segment (410) may comprise a user PC (412) and a PDA (414), which are connected in some form to web servers (420). Web servers (420) communicate with Application Servers (430) which may include an LDAP Directory Server (432), an Application Server (434), a Database Server (436), a Site Analysis Server (438) or a combination thereof. The Application Servers (430) communicate with the Data Providers (440), which comprise Data Provider Servers (442). Firewalls (450) may also be placed between each of the components 410, 420, 430 and/or 440. The Intelligent Agent (the contemplated system described in some embodiments herein) provides at least one of the core applications listed below, alone or in combination.
Access Control Application/Service (310)—This application provides authentication services for users and data providers. When the user logs in, they will be authenticated against either an internal repository of user name and passwords (Service provider mode) or will be validated using an API into the data provider's existing user repository (Product Mode). Once the user has been authenticated, they will be given access to other applications such as search.
Search Application/Service (320)—This application provides an HTML interface for the user to search for property listings in certain zip codes or geographical areas. Once the user enters the search criteria, both mandatory and optional, the request will get forwarded to the Listing Locator Application.
Listing Locator Application/Service (330)—This application obtains a list of the RETS-Client-Server URLs, usernames, and passwords for the data providers who are providing data in the searched zip codes from the distributed copy of the registry data. This connection information is forwarded to the Request Delegation Application.
Request Delegation Application (340)—This service connects and issues RETS Search requests to the data providers for property listing data, which may include property, active agent, agent, history, office, open house, prospect, tax and tour data. The responses are forwarded to the Data Filtering Application.
Data Filtering Application/Service (350)—This application applies business rules, e.g. Reciprocal Agreements, to the returned data. This module checks to ensure that the data sent adheres to the pre-agreed upon minimum exchange dataset. It then checks to see if the data provider has additional rules set up through the administration service and applies these rules to the RETS data. The RETS data set is then forwarded to the Consolidation Application.
Consolidation Application/Service (also part of 340)—This application consolidates the RETS responses, after the business rules are applied. The consolidated RETS responses are passed along to the Data Presentation Application. The consolidated results data is temporary and is deleted when the user is finished with the search request or they log off.
Data Presentation Application/Service (360)—This service takes the consolidated results and has the capability to return the data in one of a number of formats, e.g. RETS format, HTML, WML, or XML (390).
Administration Application/Service (370)—
   User Permission Maintenance Application—Add, Modify, Delete users and user information. Mapping of data provider roles to contemplated software and/or systems roles. In the product mode, the System Component provides an API to hook into the existing user database.
   Data Provider Location/Filter Maintenance Application—Ability to view their own and other data provider RETS-Client-and-Server URLs—Zip code mappings.
   Reciprocal Agreements Maintenance Application—Mapping of business and data filtering rules, mapping of roles to RETS datasets.
   Report Generation Application—Generation of system usage type reports for system monitoring and billing purposes. The contemplated system tracks the data on who, when and how the system is being used and how the system is responding to the requests. Using commercially available tools, this data can be analysed to monitor and improve contemplated systems as described herein.
Data Applications (380)—The database contains the following types of data tables, and will serve this data to other applications when it is required:
   Permissions, Users, Data Providers Tables
   Data Provider Directory Data (copy from the central registry)
   Business Rules Tables
   Audit Tables

As mentioned earlier, a user must be a valid and authenticated user before the contemplated software and/or system described herein functions. Any request entered into the contemplated software and/or system is intercepted by the Security and Authentication Module (Access Control Service in the diagram) to check the user's validity. If the user is not authenticated, the user is prompted to login using a valid login and matching password. Users who do not match this criterion will not be allowed to use the system. Users who pass this criterion will be supplied with a credential, which should be supplied by the user in each successive request. This Security and Authentication Module will be used to perform the same on all users in different roles.

Once the user is authenticated, the user's permissions will be loaded from the Authentication & Permissions database. The user is associated with a set of filtering rules that are enforced. The permissions and filtering rules are applied for all the user's results. The permissions and filters may hide or allow some of the fields in the data to pass through to the user. Two ways of storing authentication and permissions data are database and LDAP.

In Service Provider Mode, the user database will be part of the contemplated system. In Product Mode, either the contemplated system user database described herein will be used or an API may be available to hook into the existing data providers' users database. For a valid user who uses a RETS client to search for a property listing, the contemplated system described herein supports Login, Change Password, Search and Logout transactions.

The Registry stores the following: data providers' systems locations, user accounts to use for logging into these systems, and geographic areas the data providers support (zip codes, map coordinates, city). Updates and changes to the master list, which is maintained centrally, are periodically sent to all participating data providers. The system maintenance team uses the administration services to view this information. The contemplated system uses the geographic information supplied in the search request to narrow down which data providers to delegate requests to. ‘Data Provider Locator by Zip/City’, ‘Data Provider Directory Data’ comprise most of the functionality in the Registry.

The Search Application along with the Listing Locator, Request Delegation, Data Filtering, and Consolidation Applications and the RETS Connection Pool support this critical functionality in the software and/or systems described herein. This architecture can be easily extended for other searches listed in the RETS protocol.

The Search Application passes the geographic location in the search criteria to the Listing Locator Application, which narrows down the list of data providers to contact. Using this list, it hands over the request to the Request Delegation Application, which uses the appropriate connections for this user's role from the RETS connection pool to delegate the requests to the data providers. The data is forwarded to the Data Filtering Application, where the data provider filters as well as the system's filters are applied. The Consolidation Application consolidates the results. The consolidated result set is sent to the user.

Depending on the client type, the data may go through another transformation. For RETS clients, the data is shipped straight through without any modification. For HTML and WML clients, the data goes through the Data Presentation Application to be transformed. For browser clients, the result is HTML. For wireless clients, it is WML.

The data provider and the software and/or system described herein is able to enforce data filtering rules based on the user. This is done through the Data Filtering Application. There are three types of rules that are applied in the following order: data provider applies rules based on the user role, software and/or systems, such as those described herein, enforce the rules created by the data providers for the users belonging to different data providers, and finally the software and/or system described herein applies its own roles based data filtering.

The data provider controls various fields in the search results by user role. For this to happen, the system described and contemplated herein requires at least two user roles consistently across all data providers—one generic user role and one privileged user role. Generic users receive general data from the data provider. Privileged users receive general data and additional privileged fields from the data provider. This filtering takes place at the data providers systems.

Data providers maintain a set of rules for the software and/or system described herein, via the Administration Module. These rules provide the capability to filter data based on which data provider the end user belongs to. Applying this set of data filtering rules takes place system level. Each data provider sets up reciprocal data agreement rules, and the software and/or system applies these rules. The software and/or system maintains a set of roles for users. These roles may have data filtering rules. The data passes through this filter to the end user.

The Administration Application along with the databases in the architecture diagram supports the Administration functionality, such as those described earlier.

The system described herein is primarily a service provider. The system generally does not store any property listing data from the data providers. Operational data, such as authorized users, roles, data providers by their geography of service and the rules for filtering data are maintained by the system described herein.

A variety of client types can be supported with this architecture. Depending on the client type, the presentation layer translates the response appropriately. For example, a RETS client is supplied with RETS XML, and an Internet browser is supplied with HTML by the Data Presentation Application layer.

In order to support RETS clients, the contemplated system must support http (Internet not encrypted) and https (Internet encrypted) protocols. The system described herein generally only allows valid authenticated users access to the software and/or system. The required authentication is encrypted so as not to be exploited by Internet hackers and computer pirates. This security measure prevents unauthorized users from using the software and/or system.

The software and/or system described herein can be protected from network intruders by enforcing firewalls. These firewalls prevent potential intruders from accessing the software and/or system by any other means except the allowed port, which is allowed for valid users.

The data may be transmitted to the clients and accessed from the data providers in a completely encrypted form. Encryption ensures that the data stored in the software and/or system, its clients and the data providers are secure and integrity is maintained on the software and/or system level. This form of security comes at a premium. Performance can suffer significantly with this level of security. Both http and https protocols can be supported and the choice is left up to the users of the system. Some sensitive transactions may always be encrypted.

Data providers control what data they send by the user role. The software and/or system described herein applies the data controls set up by the data provider to the data. The software and/or system also uses a set of accounts that each data provider provides, to access data from the data providers. There is one account per agreed upon role. The software and/or system also provides a set of roles to apply additional filters on the data provided by the data provider. These contemplated requirements meets the needs of permissions scheme discussed in requirements gathering.

Table 2 defines several of the contemplated user roles that may be available within the software and/or system described herein. This module will be flexible enough to add new roles. Roles will be determined during the detailed design phase.

TABLE 2

| | Description (The Data Provider will need to map |
|---|---|
| Roles for System | their internal roles to the System Roles) |
| Generic User | User who is not a member of |
| (Default) | the data provider he is searching |
| | Will get access to a preset list of data fields. |
| Privileged | User who is not a member of the data provider |
| Associated User | he is searching, however, his |
| | data provider has a special reciprocal agreement in |
| | place with the data provider he is a member of. |
| | User will get access to a preset list of data |
| | fields plus extra fields that are |
| | definable through the System. |
| Privileged User | User who is a member of the data provider he |
| | is searching. Will get access to a preset list of data |
| | fields plus all privileged data fields that |
| | the data provider shows to its members |
| Data Provider | User who will be responsible for maintaining |
| | the operational data for that data |
| Administrator | provider |
| System | User who will administer and change |
| Administrator | configuration parameters of the System. |

The software and/or system described herein is an XML intensive application. Once the results are gathered from the data providers, the system performs CPU intensive operations to consolidate results, apply data filters, and convert to HTML for browser clients (if any) and encrypt (if any). Based on these preliminary performance operations, performance of the software and/or system should be acceptable on properly sized servers. In this architecture, the software and/or system depends on the data supplied by the data providers. For every search request from the client, one to many data providers' systems may have to be contacted. This means that the performance depends on the data providers' systems performance and the network latency. To optimize this, a pool of readily available connections to the data providers is maintained. This measure minimizes the connection time.

The software and/or system described herein is designed to support other property information standards. Although this specification only defines property listing search functionality (and Office and Agent), the software and/or system can easily be extended to support other types of searches defined in the RETS protocol. This architecture can be extended to support the RETS Update transaction. The proposed architecture is highly extensible. In addition to RETS clients, it can support browser clients and PDA clients without major modifications.

The architecture described herein is not specific to any technology platform. It can be implemented in Java or Microsoft technology on any hardware platform. The solution should be based on open standards as much as possible. Open standards imply a Java based implementation.

Audit trail logging is used to keep track of significant user actions, typically for legal and accounting purposes. The fulfillment of this requirement may overlap heavily with the logging of user actions for site analysis purposes. The system described herein has the potential to track the following:
When and who is attempting a login request.
When a request comes in for a list of data providers by zip.
The searches performed, i.e. which attributes were used for search, and what the values of the search criteria were.
If the data provider is available or whether their systems are down.
Application error monitoring.
Response time of data providers and overall system.

Debug logging is mostly a development function, but should be left as a configurable option in the event that system is experiencing difficulties that are difficult to diagnose.

It is contemplated that session management includes tracking the user's state for a given session. Each user, depending on which data provider they belong to, depending on which data provider they are requesting data from, will have a set of data filtering rules associated with their session. Depending on the user's role, the system described and contemplated herein applies an additional set of filtering rules. These rules will be associated to the user's session. The above mentioned applies to a RETS client. In case of a browser client, the data and rules in addition to the above mentioned may need to be stored. For scalability purposes, the data stored in the user's session will be kept to a minimum.

Generally, there are three types of errors—user errors, system errors, and application errors. User errors include when a user provides an incorrect value or attempts to do something that is not allowed. System errors are when a service fails to respond, a server is down, etc. Application errors indicate something unexpected happening within the code—for example, a null object.

The software and/or system contemplated herein captures system and application errors in log files or in the database and may have some kind of email notification to notify the administrator if something is going on with the system. It needs to integrate with a SMTP email server in order to provide this type of notification.

RETS standard version 1.0 is one of the contemplated versions; however, Version 1.5 and any other subsequently developed version, such as version 2.0, can be used and is contemplated.

There are two aspects of the RETS standard in the software and/or system described herein. The system should support RETS clients. The software and/or system should have the ability to return the consolidated data in a RETS format. One of the contemplated requirements for a participating data provider operating in server mode is that they make a RETS compliant interface available, which is required in order for the system to communicate with their systems. In service provider mode, the data providers will require a RETS compliant interface that can facilitate the RETS server mode. In product mode, the data providers will require a RETS complaint interface that can facilitate both the RETS server and RETS client mode. The system also uses RETS protocol to send requests to data providers and consolidates the corresponding returned RETS XML format results to its clients.

Table 3 shown below shows the level of RETS compliance required by the software and/or system described herein and by participating data providers. This table specifies compliance as absolute minimum in addition to what NAR has specified as “being RETS Compliant”:

TABLE 3

| | | | Required from |
|---|---|---|---|
| | | Required for | other RETS |
| | | Intelligent Agent | servers located at |
| | | (in service | participating |
| | | provider mode i.e. | Data Providers |
| RETS Compliance | | using a RETS | (in service |
| Area | Description | client) | provider mode) |
| Transactions | | | |
| Login | To login | Must Support | Must Support |
| Change Password | To change password | Must Support | Must Support |
| GetObject | To get Images | Must Support | Must Support |
| Search | To search property data | Must Support | Must Support |
| GetMetadata | To get the data dictionary of the system | Must Support | Must Support |
| Get | To get files | Must Support | Must Support |
| Logout | To logout | Must Support | Must Support |
| DTD Types | | Compliant/non- | Compliant/non- |
| | | Compliant | Compliant |
| RETS DTD | XML data transfer with starting and ending tags | Must Support | Must Support |
| Format | around each data item. | | |
| | The XML format does not have a corresponding | | |
| | ‘DECODED’ flag. Data transferred in the XML | | |
| | format must always be decoded, because given a | | |
| | particular set of data formatted in XML, the client | | |
| | would have no way to determine if the data for a | | |
| | field was a coded or an actual representation. | | |
| Searches | At least one of the following searches should be | Compliant/non- | Compliant/non- |
| | supported. For Intelligent Agent ‘Property’ search | Compliant | Compliant |
| | will be supported initially. The following are well | | |
| | known searches. | | |
| Property | A Property Search is a search against the property | Must support | Must support |
| | database/tables. If the server supports a cross- | | |
| | property search then the metadata will define a class | | |
| | to use to perform the cross-property search. | | |
| Agent | An Agent Search is a search against the | Must support | Must support |
| | Agent/Member database/table. It is used for | | |
| | retrieving information about the agents. | | |
| History | A History Search is a search against the history | Optional for Phase 1 | Optional for Phase 1 |
| | database/table. | | |
| Office | An Office Search is a search against the office | Must support | Must support |
| | database/table. It is used for retrieving information | | |
| | about the offices. | | |
| Open House | An OpenHouse Search is a search against the Open | Optional for Phase 1 | Optional for Phase 1 |
| | House database/table. | | |
| Active Agent | An ActiveAgent Search is a search against the | Must support | Must support |
| | Agent/Member database/table. This search only | | |
| | returns active agents. These are agents that are | | |
| | currently authorized to access the server (paid-up, | | |
| | not retired, etc.) | | |
| Prospect | A Prospect Search is a search against the Prospect | Optional for Phase 1 | Optional for Phase 1 |
| | database/tables. A Prospect Search is used to | | |
| | retrieve prospect information from the server | | |
| | database. | | |
| Tax | A Tax Search is a search against the public records | Optional for Phase 1 | Optional for Phase 1 |
| | database/tables. Many systems have multiple | | |
| | public record databases. Each public record | | |
| | database is assigned a class number. This class | | |
| | number is used by the client application when | | |
| | submitting a search to distinguish which database | | |
| | the search will be conducted against. | | |
| Tour | A Tour Search is a search against the Tour | Optional for Phase 1 | Optional for Phase 1 |
| | database/table. | | |
| MetaData | | Compliant/Non | Compliant/Non |
| Compliance Area | | Compliant | Compliant |
| Agent | | Must Support | Must Support |
| Office | | Must Support | Must Support |
| Tax | | Optional for Phase 1 | Optional for Phase 1 |
| Property | | Must Support | Must Support |
| (Listing) | | | |
| Searchable | | Must Support | Must Support |
| columns | | | |
| Add/Update | | Optional for Phase 1 | Optional for Phase 1 |
| column | | | |
| requirements | | | |
| Primary | | Must Support | Must Support |
| Keys | | | |

RETS has defined the following package type elements shown in Table 4 in its DTD. There are four property types that the DTD supports. They are: Residential, Common Interest, Lots and Land, and Multi Family.

TABLE 4
RETS PACKAGES

```
REData
  REProperties?
    ResidentialProperty*
    CommonInterest*
    LotsAndLand*
    MultiFamily*
    TaxData*
  REOffices?
    REOffice+
  REAgents?
    REAgent+
  REOfficeRosters?
    REOfficeRoster+
```

RETS fields that are currently available for each package type are listed below in Table 5. It has not been determined if these fields would meet the minimum agreed upon dataset for the software and/or system described herein, which will be determined during additional design.

TABLE 5
PROPERTY TYPE - RESIDENTIAL PROPERTY

```
<ResidentialProperty>
  <Listing>
    <StreetAddress>
      <StreetNumber>
      <BoxNumber>
      <StreetDirPrefix>
      <StreetName>
      <StreetAdditionalInfo>
      <StreetDirSuffix>
      <StreetSuffix>
      <UnitNumber>
      <City>
      <StateOrPrivince>
      <Country>
      <PostalCode>
      <CarrierRoute>
      <Unstructured>
    <ListingData>
      <REAgent>
        <FirstName>
        <LastName>
        <ContactInformation>
          <OfficePhone>
          <CellPhone>
          <HomePhone>
          <Fax>
          <Pager>
          <Email>
          <WWW>
        <StreetAddress>
          <StreetNumber>
          <BoxNumber>
          <StreetDirPrefix>
          <StreetName>
          <StreetAdditionalInfo>
          <StreetDirSuffix>
          <StreetSuffix>
          <UnitNumber>
          <City>
          <StateOrProvince>
          <Country>
          <PostalCode>
          <CarrierRoute>
          <Unstructured>
        <ListingServiceName>
        <AgentID>
        <NRDSMemberID>
      <REOffice>
        <Name>
        <ContactInformation>
          <OfficePhone>
          <CellPhone>
          <HomePhone>
          <Fax>
          <Pager>
          <Email>
          <WWW>
        <StreetAddress>
          <StreetNumber>
          <BoxNumber>
          <StreetDirPrefix>
          <StreetName>
          <StreetAdditionalInfo>
          <StreetDirSuffix>
          <StreetSuffix>
          <UnitNumber>
          <City>
          <StateOrProvince>
          <Country>
          <PostalCode>
          <CarrierRoute>
          <Unstructured>
        <ListingServiceName>
        <OfficeID>
        <BrokerID>
        <NRDSOfficeID>
      <ListDate>
      <ListPrice>
      <OriginalListPrice>
      <ExpirationDate>
      <ShowingInstructions>
      <ListingType>
      <Commission>
      <Remarks>
      <PublicRemarks>
    <MLSInformation>
      <ListingStatus>
      <ListingArea>
      <StatusChangeDate>
      <DaysOnMarket>
      <ListingServiceName>
    <GeographicData>
      <Latitude>
      <Longitude>
      <County>
      <Directions>
      <MapCoordinate>
      <URL>
    <ModificationTimestamp>
    <ListingID>
    <Zoning>
    <SalesData>
      <REAgent>
        <FirstName>
        <LastName>
        <ContactInformation>
          <OfficePhone>
          <CellPhone>
          <HomePhone>
          <Fax>
          <Pager>
          <Email>
          <WWW>
        <StreetAddress>
          <StreetNumber>
          <BoxNumber>
          <StreetDirPrefix>
          <StreetName>
          <StreetAdditionalInfo>
          <StreetDirSuffix>
          <StreetSuffix>
          <UnitNumber>
          <City>
          <StateOrProvince>
          <Country>
          <PostalCode>
          <CarrierRoute>
          <Unstructured>
        <ListingServiceName>
        <AgentID>
        <NRDSMemberID>
      <REOffice>
        <Name>
        <ContactInformation>
          <OfficePhone>
          <CellPhone>
          <HomePhone>
          <Fax>
          <Pager>
          <Email>
          <WWW>
        <StreetAddress>
          <StreetNumber>
          <BoxNumber>
          <StreetDirPrefix>
          <StreetName>
          <StreetAdditionalInfo>
          <StreetDirSuffix>
          <StreetSuffix>
          <UnitNumber>
          <City>
          <StateOrProvince>
          <Country>
          <PostalCode>
          <CarrierRoute>
          <Unstructured>
        <ListingServiceName>
        <OfficeID>
        <BrokerID>
        <NRDSOfficeID>
      <ContractDate>
      <ClosePrice>
      <CloseDate>
    <SchoolData>
      <SchoolDistrict>
      <ElementarySchool>
      <MiddleSchool>
      <HighSchool>
    <TaxData>
      <StreetAddress>
        <StreetNumber>
        <BoxNumber>
        <StreetDirPrefix>
        <StreetName>
        <StreetAdditionalInfo>
        <StreetDirSuffix>
        <StreetSuffix>
        <UnitNumber>
        <City>
        <StateOrProvince>
        <Country>
        <PostalCode>
        <CarrierRoute>
        <Unstructured>
      <MailingAddress>
        <StreetAddress>
          <StreetNumber>
          <BoxNumber>
          <StreetDirPrefix>
          <StreetName>
          <StreetAdditionalInfo>
          <StreetDirSuffix>
          <StreetSuffix>
          <UnitNumber>
          <City>
          <StateOrProvince>
          <Country>
          <PostalCode>
          <CarrierRoute>
          <Unstructured>
      <TaxID>
      <County>
      <ModificationTimestamp>
      <LegalDescription>
      <OwnersName>
      <AssessedValuation>
      <PropertyZoning>
      <ParcelMapURL>
    <ParcelNumber>
    <View>
    <CopyrightNotice>
    <Disclaimer>
    <PictureData>
  <Bedrooms>
  <Baths>
    <BathsTotal>
    <BathsFull>
    <BathsHalf>
    <BathsThreeQuarter>
  <Subdivision>
  <AssociationFee>
  <LivingArea>
    <Area>
  <LotSize>
    <Dimensions>
    <Length>
    <Width>
    <Area>
  <Parking>
    <Garage>
    <CarPort>
    <OpenParking>
    <CoveredParking>
  <Stories>
  <YearBuilt>
  <Heating>
  <Cooling>
  <Pool>
  <InteriorFeatures>
  <ExteriorFeatures>
  <Type>
  <Style>
  <Rooms>
    <DiningRoom>
      <Dimensions>
      <Length>
      <Width>
      <Area>
    <LivingRoom>
      <Dimensions>
      <Length>
      <Width>
      <Area>
    <FamilyRoom>
      <Dimensions>
      <Length>
      <Width>
      <Area>
    <Basement>
      <Dimensions>
      <Length>
      <Width>
      <Area>
    <TotalRooms>
  <Occupant>
    <Name>
    <ContactInformation>
      <OfficePhone>
      <CellPhone>
      <HomePhone>
      <Fax>
      <Pager>
      <Email>
      <WWW>
  <WaterFront>
  <Fireplaces>
  <Roof>
  <Exterior>
```

PROPERTY TYPE - COMPLEX

```
<Complex>
  <BuildingType>
  <TotalUnits>
  <BuildingName>
  <ComplexFeatures>
```

PROPERTY TYPE - MULTIFAMILY

```
<MultiFamily>
  <RentIncome>
  <GrossIncome>
  <Expenses>
  <NetIncome>
  <VacancyFactor>
  <TenantPays>
  <OwnerPays>
  <Laundry>
  <Unit>
    <Bedrooms>
    <Bathrooms>
    <RentIncome>
    <AssociationFee>
    <LivingArea>
      <Size>
    <Parking>
      <Garage>
      <CarPort>
      <OpenParking>
      <CoveredParking>
    <Stories>
    <Heating>
    <Cooling>
    <InteriorFeatures>
    <Rooms>
    <Occupant>
    <Fireplaces>
```

PROPERTY TYPE - LOTS AND LAND

```
<LotsAndLand>
  <Utilities>
  <PresentUse>
  <Topography>
  <ParcelAccess>
  <DevelopmentStatus>
  <ExistingStructures>
```

RETS was built for a one data provider—multiple client model concept. RETS is not ideal to support multiple data providers—multiple clients model, which is what contemplated software and/or systems facilitate. If the software and/or system described herein is gathering data from multiple data providers, the returned RETS data may need to be stamped with the data providers ID, so that the software and/or system will know where the information came from should it need to get more information or images etc. from the data provider. The information shown in Table 6 is contemplated and may be considered as an extension to the RETS standard. It could be added at the package level. Other RETS extensions could be considered, such as adding a field for the participating data provider id so that it is known where the RETS record originated from.

TABLE 6
RETS PACKAGE LEVEL ELEMENTS

```
REData
  Data Provider Identifier -NEW Element
  Data Provider Name - NEW Element
  REProperties?
    ResidentialProperty*
    CommonInterest*
    LotsAndLand*
    MultiFamily*
    TaxData*
  REOffices?
    REOffice+
```

The following assumptions are made regarding the RETS clients:
Only property, agent, and office searches are in scope, however, additional searches can be extended in the future with minimal effort assuming all data providers support the searches.
Search parameters must be in RETS ‘Standard Names’ only. Compact data or Compact decoded data format will not be supported. Only RETS XML format is supported.
Search parameters will be a set of least common denominator between all data providers.
All requests sent to the data providers will have a unique request ID. The software and/or system described herein expects this request ID to be sent back in response. (standard RETS requirement)
Users will provide which data provider they belong to when they sign up with the contemplated software and/or system. This will help in applying the data filtering rules accordingly.
User can only insert a property listing record into the data provider system they belong to.
Users can only update a property listing record that they insert (own) into the data providers' systems.
Since the software and/or system described herein deals with multiple data providers, it has to keep track of what data came from where. To keep track of this data, the Intelligent Agent may prefix the IDs in the data with a data provider code. This code could be at most 3 characters long. This action helps in implementing the ‘Update’ transaction in the future. There is a very small probability that this modification to the ID fields may exceed RETS stipulated field lengths in its XML.

The following assumptions are made regarding the Data Provider RETS Implementation:
Data providers will have a consistent number of roles for software and/or system's use. This will enable data providers to properly filter data by the user role.
Data providers will make an effort to provide a least set of common denominator search fields. This set, at least, has to encompass most commonly used search fields.
The search fields supported must map to ‘Standard Names’ in the RETS DTD.
Each data provider provides one account for each different role they support.
The software and/or system described herein assumes that the data providers accept multiple connections simultaneously with the same account.
Data providers and the software and/or system described herein should coordinate so that the geographic service areas are kept up to date for accurate searches.

The architecture contemplated herein is generally highly scalable. It is a service-oriented solution where a very limited amount of data is maintained for operational purposes. Due to the service-oriented nature of the Intelligent Agent application, it can be run on multiple server machines simultaneously to achieve desired scalability. As more servers are added for scalability, the data providers will receive more and more requests from the software and/or systems described herein. At that point, the limiting factors may be the capacity, scalability and performance of some of the data providers' servers. California Association of Realtors (CAR) members and the real estate business community in California will eventually use the software and/or system described herein, dubbed the ‘INTELLIGENT AGENT™’, to perform their daily job duties.

The response time of the software and/or system described herein depends on the participating data providers' systems. The software and/or system generally cannot control this aspect. The system described herein generally has response time that is in the range of the best response time of a data provider and the worst response time of a data provider. Depending on the amount of data involved and the network latency, the response time could be up to an additional 5 seconds beyond the data providers' normal response time. Response time would be best if sorting of results is not required, because the system would not have to wait for all data providers to respond prior to its next task. The system should wait for all data providers to respond if sorting is required.

Eventually, over 100,000 users could be using the software and/or system described herein. The usage patterns and the peak usage will need to be deduced by current MLS systems usage. The number of transactions and the rate of transactions will also need to be deduced by current MLS systems usage. Depending on the mode the system is deployed in, the load would differ greatly. In product mode, the numbers of users are limited to users of that data provider.

The system is designed to be deployed on multiple server machines for scalability purposes. It also addresses the mission critical nature requirement of the application. Because the system will be deployed on multiple machines, each server being equivalent to any other server in the deployment, even if one of them or several of them fail the application as a whole will function normally.

Other than the update transaction, the software and/or system transaction types are read only transactions. The update transaction for any particular user will only take place with one designated data provider (i.e. the update transaction does not span multiple data providers). The actual update will be processed at the data providers' systems. The software and/or system itself is not responsible for the successful completion of the update transaction. Data Provider's systems are responsible for completion of the update transaction. Based on this, distributed transaction management software should not be necessary.

If transactions are to span multiple data providers as well as other entities (title companies, mortgage bankers) of real estate business, then there will be a need for transaction management software. At the writing of this document, there are no commercial transaction management software packages or specifications that span multiple web-based systems.

Contemplated architectures for the system's production environment, as discussed below, are not necessarily representative of the physical architecture—they are represented by a logical architecture.

The system is designed to be scalable. It will be based on a 3-tier architecture with operational units defined at each tier. The 3 tiers are web, application server and database. The premise is that should capacity or number of concurrent users increase, simply adding operational units to each tier will provide the ability to support the increased capacity.

The scalability of the solution can be addressed from the perspective of the overall architecture, hardware, and software. These three components are tightly coupled when addressing scalability. The bottleneck within any system can be found at any tier of the application or in some cases be external to the solution such as firewall or network related issues.

### EXAMPLES

### Example 1

### Typical User Scenario

Contemplated sequence of operations in this distributed application architecture are as follows:

1. Agent logs in through the use of the Login and Permissions Module, which proceeds to validate that that user is a valid user.

2. The agent uses the Search Module to conduct a search for property listings in zip code, e.g., 94105.

3. The Registry Module gets a list of Data Providers who provide property listings for 94105 and contacts each Data Provider in the list. Each Data Provider provides the property listings for 94105 to the Search Module.

4. The Business Rules Module applies the data filters to the data, and presents the data to the client.
5. Agent logs off.

### Example 2

### Typical Usage Scenario (FIG. 1)

1. Agent 1 logs in and is authenticated as a valid user of the software and/or system, which resides at a hosted location. (The client interface may be a Browser)

2. Agent 1 issues a Search request based on zip code. The contemplated system obtains the list of data providers based on the Agent 1 search zip code. The contemplated system also maintains a copy of the data providers to zip code mappings. This is periodically updated from the Central Registry.

3. The contemplated system sends the search request (in RETS format) to each of the data providers' systems (RETS Client and Server Mode).

4. The contemplated system consolidates the search results from the data providers and sends to the client.

5. The results are displayed to the client.

6. Agent 1 logs off.

### Example 3

### Typical Usage Scenario (FIG. 2)

1. Agent 1 logs and is authenticated as a valid user of the software and/or system, which resides at his data provider. (The client interface will be a Browser)

1. Agent 1 issues a search request based on zip code. The Intelligent Agent obtains the list of data providers based on the Agent 1 search zip code. The Intelligent Agent maintains a copy of the data providers through the—Zip Code—RETS—Client-and-Server URL Mappings. It is contemplated that the system is periodically updated from the Central Registry.

2. The Intelligent Agent sends the search requests in RETS format to each of the data providers' systems (RETS-Client-and-Server Mode).

3. The Intelligent Agent consolidates the search results from the data providers. It is possible that the Intelligent Agent will search his own data provider's system, if it matches the zip code criteria.

4. The results are displayed to the client.

5. Agent 1 logs off.

### Example 4

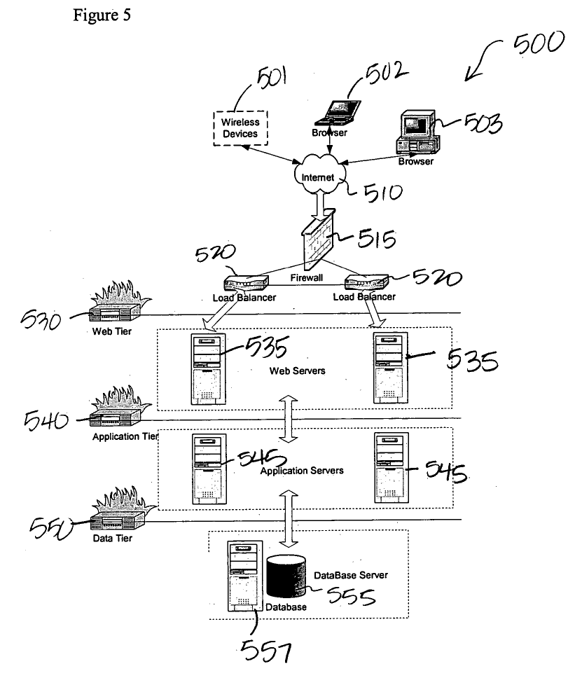

### Diagram of Potential System Architecture (Service Provider Mode)—Shown in FIG. 5

FIG. 5 shows a contemplated embodiment (500) of a system architecture for a Service Provider mode. Client-side environments, such as wireless devices (501), laptops (502) and/or desktop computers (503) are provided that are browser-enabled and may connect to the Internet (510). A firewall (515) may be established between the Internet (510) and the load balancers (520). The load balancers (520) connect to and communicate with at least one of the web tier (530), the application tier (540) and/or the data tier (550), which also communicate with one another. The web tier (530) comprises web servers (535). The application tier (540) comprises application servers (545). The data tier (550) comprises database servers (555) and at least one database (557).

In one embodiment, the client-side environments may include any number of hardware vendors, including Dell, Hewlett-Packard, IBM and Sun Microsystems, may include any suitable operating system, such as Microsoft or Linux, and may run with any number of hardware and operating systems combinations.

The web tier (530) may include at least one CPU that comprises 10-20 GB of disk space and 0.5 GB of memory or more. With respect to the software, the web tier (530) may comprise an application server plug-in, such as an Apache web server (such as version 2.0).

The application tier (540) may include at least two CPU that comprise at least 30 GB of disk space and at least 1 GB of memory. With respect to the software, the application tier (540) may comprise JBOSS, TomCat, Weblogic, WebSphere and/or IPlanet.

The data tier (550) should be scalable to at least 8 CPU and should have initial requirements similar to those of the application tier (540). However, the data tier (550) is contemplated to be easily expandable, as with the web tier (530) and the application tier (540). With respect to the software, the data tier (550) may use any suitable database software, such as MySQL, SQL Server and/or Oracle 8i.

### Example 5

User Logs in to an Embodiment of the System Described

[image]

### Example 6

### User Performs a Search

The following event diagram illustrates a RETS client search scenario. In this scenario, it is assumed that the user is already logged into the system and has permission for search. A Legend is provided below to show how a search works in the system.

[image]

Legend for Search Scenario

| | |
|---|---|
| User Session | US |
| Data Presentation Services | DPS |
| User Authentication Service | UAS |
| Data Filter | DF |
| Property Search Service | PSS |
| Request Delegation/Response Consolidation | RDRC |
| RETS Connection Pool | RCP |
| Data Provider Locator | DPL |
| Data Provider 1 | DP1 |
| Data Provider 2 | DP2 |
| Data Provider Directory | DPD |

1. User issues a search in zip code 90001

2. RETS Module checks to see if the user is already logged in.

3. RETS module then delegates the request to Property Search Application.

4. Property Search Application using 90001 as criteria locates the Data Providers providing the service in that area.

5. Property Search Application then delegates the request to Request Dispatcher/Response Consolidator.

6. Request Dispatcher gets RETS connections from the pool with appropriate role.

7. Request Dispatcher sends the search request to Data Provider 1.

8. Request Dispatcher sends the search request to Data Provider 2.

9. Request Dispatcher receives results from Data Provider 1.

10. Request Dispatcher receives results from Data Provider 2.

11. Response Consolidator consolidates the results applying the modifications to identify the result source.

12. Response Consolidator returns consolidated results to the Property Search Application.

13. Property Search Application fetches the data filtering rules from this user session.

14. Data Filter applies the filtering rules and Intelligent Agent role based filtering rules.

15. Filtered results are returned back to Property Search Application.

16. Return the results to the RETS Module.

17. RETS Module sends the results to client.

1. A system for identifying, retrieving and manipulating real property data and information, the system comprising:
real property data from at least one source;
software that executes in a node environment, wherein the software performs at least one of the following functions: identifying a set of real property data, retrieving a set of real property data or manipulating a set of real property data from the at least one source, wherein at least one of the identification, the retrieval or the manipulation of the real property data forms a results set; and
a display apparatus for displaying the results set.

2. The system of claim 1, wherein the at least one source comprises a multiple listing system.

3. The system of claim 2, wherein the multiple listing system utilizes the RETS protocol.

4. The system of claim 1, wherein the at least one source comprises at least two sources.

5. The system of claim 4, wherein at least one of the sources comprises a multiple listing system.

6. The system of claim 1, wherein the at least one source comprises a participating broker, an appraiser, a title company, public records or a combination thereof.

7. The system of claim 1, wherein the software performs at least two of the following functions: identifying a set of real property data, retrieving a set of real property data or manipulating a set of real property data from the at least one source, wherein at least one of the identification, the retrieval or the manipulation of the real property data forms a results set.

8. The system of claim 7, wherein the software performs all of the following functions:
identifying a set of real property data, retrieving a set of real property data and manipulating a set of real property data from the at least one source, wherein at least one of the identification, the retrieval or the manipulation of the real property data forms a results set.

9. The system of claim 1, wherein the display apparatus comprises a hand-held device, a monitor coupled with a laptop computer or a monitor coupled with a desktop computer.

10. The system of claim 1, wherein the node environment comprises at least one wireless component.

11. A software package, comprising:
at least one software application that executes in a node environment, wherein the at least one software application performs at least one of the following functions:
identifying a set of real property data, retrieving a set of real property data or manipulating a set of real property data from the at least one source, wherein at least one of the identification, the retrieval or the manipulation of the real property data forms a results set.

12. The software package of claim 11, wherein the at least one software application comprises at least one module.

13. The software package of claim 11, wherein the at least one module comprises a business rules module, a contracts module, an administration module, a registry module, a search module or a combination thereof.

14. The software package of claim 11, wherein the node environment comprises at least one client.

15. The software package of claim 11, wherein the at least one source comprises a multiple listing system.

16. The software package of claim 15, wherein the multiple listing system utilizes the RETS protocol.

17. The software package of claim 10, wherein the at least one source comprises at least two sources.

18. The software package of claim 17, wherein at least one of the sources comprises a multiple listing system.

19. The software package of claim 10, wherein the at least one source comprises a participating broker, an appraiser, a title company, public records or a combination thereof.
